(19) United States
(12) Patent Application Publication
(10) Pub. No.: US 2010/0183004 A1
(43) Pub. Date: Jul. 22, 2010

(54) SYSTEM AND METHOD FOR DUAL MODE COMMUNICATION BETWEEN DEVICES IN A NETWORK

(75) Inventor: Osamu Kobayashi, Los Altos, CA (US)

Correspondence Address: STMICROELECTRONICS, INC., MAIL STATION 2346 , 1310 ELECTRONICS DRIVE, CARROLLTON, TX, 75006, US

(73) Assignee: STMICROELECTRONICS, INC., Carrollton, TX (US)

(21) Appl. No.: 12/484,796

(22) Filed: Jun. 15, 2009

Related U.S. Application Data
(60) Provisional application No. 61/145,472, filed on Jan. 16, 2009.
(60) Provisional application No. 61/172,165, filed on Apr. 23, 2009.
(60) Provisional application No. 61/177,973, filed on May 13, 2009.

(51) Int. Cl. H04L 12/56

(52) U.S. Cl. 370/389

(57) ABSTRACT

A packet based display interface configured to operate in a multimedia device in a network and methods to train the packet based display interface is disclosed. The packet based display interface includes a media transport block to communicate video packets across a first unidirectional link, a dual data transport block to communicate packet messages to and from client service blocks across a bidirectional link using multiple transport protocols, and a detection block to determine the addition or deletion of a network device using a second unidirectional link. Each transport protocol uses a different message format on the bidirectional link. The training methods include exchanging messages to determine transport protocol capabilities, training the bidirectional link and setting the transport protocols used. The first and second unidirectional links run in opposite directions, and both the unidirectional links and the bidirectional link use separate physical communication lines bundled together in a common cable.

### CROSS-REFERENCE TO RELATED APPLICATIONS

This patent application claims the benefit of priority under 35 U.S.C. 119(e) to (i) U.S. Provisional Patent Application Ser. No. 61/145,472 filed on Jan. 16, 2009 entitled “DISPLAY PORT USB” by Kobayashi, (ii) U.S. Provisional Patent Application Ser. No. 61/172,165 filed on Apr. 23, 2009 entitled “DISPLAY PORT USB” by Kobayashi, and (iii) U.S. Provisional Patent Application Ser. No. 61/177,973 filed on May 13, 2009 entitled “DUAL MODE SIDEBAND PROTOCOL” all of which are hereby incorporated by reference herein for all purposes.

This patent application is also related to U.S. patent application Ser. No. 10/726,794 filed Dec. 2, 2003 and entitled “PACKET BASED VIDEO DISPLAY INTERFACE AND METHODS OF USE THEREOF,” and U.S. patent application Ser. No. 12/423,724 filed Apr. 14, 2009 and entitled “SYSTEM AND METHOD FOR ENABLING TOPOLOGY MAPPING AND COMMUNICATION BETWEEN DEVICES IN A NETWORK,” both of which are hereby incorporated by reference herein for all purposes.

### TECHNICAL FIELD

The present invention relates generally to the communication networking of devices using multiple protocols in multimedia networks. More particularly, methods, software, hardware, and systems are described for using, training and switching between multiple protocols in a multimedia network.

### BACKGROUND OF THE INVENTION

Advances in multimedia components and increased sophistication in network architectures and device capabilities has made for an increasing need to support a wide range of networking communication capabilities in multimedia devices. Many multimedia devices presently include separate media dependent interfaces, such as for video or audio, and data interfaces, such as for control or data. Multiple interfaces on each device can require multiple cables to connect two devices that have both media and data capabilities. While media dependent interfaces have historically been based on analog communication methods (VGA, Component Video), more recently digital communication methods (DVI, HDMI) have advanced to offer higher quality and greater flexibility in connecting a multimedia source device with a multimedia reproduction device. These interfaces have focused on upgrading the media dependent link but have only offered limited (if any) capability for data traffic. Thus many multimedia devices currently offer separate interfaces for high rate media and for high rate data, necessitating at least two different cables between a source device and a display device. For example many computer displays now include data interfaces such as USB ports that connect to a personal computer through a USB cable that is physically separate from a digital video cable that also connects between the display and the personal computer. Multimedia devices continue to include separate interface connectors for communicating video and high rate data on separate cables between a source device and a display device. Thus there exists a need for a digital communication interface that can support both high speed video and data transmission on a single interface connector and cable between devices in a multimedia network.

### SUMMARY OF THE INVENTION

A packet based display interface configured to operate in a multimedia device in a network is disclosed that includes a media transport block to communicate video packets across a first unidirectional link, a dual data transport block to communicate packet messages to and from client service blocks across a bidirectional link using multiple transport protocols, and a detection block to determine the addition or deletion of a network device using a second unidirectional link. The first and second unidirectional links operate in opposite directions, and both unidirectional links and the bidirectional link use separate physical communication lines bundled together in a common cable.

In an embodiment of the invention, the dual data transport block includes arbitration blocks that combine messages from a plurality of client services in the client service blocks for communication across the bidirectional link using dual transport blocks and dual transport protocols. Each transport block includes physical layer and link layer blocks. In a described embodiment, two different physical layers operate at substantially different data rates, and two different link layers use distinct message formats.

In another embodiment, a method for training a packet display interface in a networked multimedia source device to use dual transport protocols is described. The method includes detecting by the source device through a unidirectional link a connection of a multimedia sink device to the packet display interface, exchanging a set of messages between the source and sink devices through a bidirectional link to determine the transport protocol capability of the sink device, transmitting and receiving training patterns between the source and sink devices using the bidirectional link, and sending a message from the source device to the sink device across the bidirectional link to set a transport protocol. The message exchanges use a first transport protocol, while the training patterns use a second transport protocol.

In a further embodiment of the invention, a method for training a packet display interface in a multimedia sink device to use dual transport protocols is described. The method includes receiving a message from a multimedia source device across a bidirectional link requesting training of the bidirectional link, transmitting and receiving training patterns between the source and sink devices using the bidirectional link, and receiving a message by the sink device to set a transport protocol. The message exchanges use a first transport protocol, while the training patterns use a second transport protocol.

In another embodiment of the invention, an electronic device configured to operate in a multimedia network is described. The electronic device includes media transport circuitry to communicate video packets across a unidirectional link, dual data transport circuitry to transmit and receive packetized data messages from two client services using two transport protocols across a bidirectional link, and detection circuitry to determine the presence of a second electronic device in the multimedia network through a second unidirectional link. The first and second unidirectional links operate in opposite directions on separate physical communication lines bundled with the bidirectional link in a common cable.

In yet another embodiment of the invention, a computer program product having computer readable instructions for communicating video packets and packetized data messages through a multimedia network is described. The computer program product includes instructions for communicating video packets across a unidirectional link, instructions for transmitting and receiving data messages through a bidirectional link, and instructions for determining the presence of a network device in the multimedia network through a second unidirectional link operating in a direction opposite to the first unidirectional link. Two client services in the computer program product communicate data messages with the network device using two transport protocols. The first and second unidirectional links and the bidirectional link each use separate physical lines bundled together in a common cable.

### BRIEF DESCRIPTION OF THE DRAWINGS

The invention and the advantages thereof can best be understood by reference to the following description taken in conjunction with the accompanying drawings.

FIG. 1 illustrates an embodiment of a multimedia network of source, branch and sink devices connected by links in accordance with the principles of the invention.

FIG. 2 illustrates multiple packetized streams connecting through transceivers in multimedia devices to a multiple connection communication link between networked devices.

FIG. 3 illustrates an embodiment of communication processing blocks within transceivers of networked devices connected through auxiliary channel links.

FIG. 4 illustrates a detailed embodiment of transceivers that communicate packetized data from auxiliary channel clients and packet data from a USB client across an auxiliary channel link between a source device and a sink device.

FIG. 5 illustrates a detailed embodiment of transceivers in a branch device connected to both a source device and a sink device and virtual channels supported between clients within the branch, source and sink devices across an auxiliary channel link.

FIG. 6 illustrates two distinct physical layer protocols and two distinct link layer protocols that form part of a dual transport communication block of a transceiver in a multimedia device.

FIG. 7 tabulates detailed properties of the two distinct physical layer and link layer protocols of FIG. 6.

FIGS. 8A, 8B and 8C illustrate a flow chart for training a dual transport communication block of a transceiver in a source device that uses a dual mode protocol.

FIG. 9 illustrates a flow chart for training a dual transport communication block of a transceiver in a sink device that uses a dual mode protocol.

FIG. 10 illustrates a multimedia network connecting a personal computer source device to multiple display sink devices and other data sink devices through an intermediate combined hub/sink device in accordance with an embodiment of the invention.

FIG. 11 illustrates a multimedia network connecting multiple source devices to multiple display devices through an intermediate hub device in accordance with an embodiment of the invention.

### DETAILED DESCRIPTION OF EXAMPLE EMBODIMENTS

The present invention relates generally to the communication networking of devices using multiple protocols in multimedia networks. More particularly, methods, software, hardware, and systems are described for using, training and switching between multiple protocols in a multimedia network.

In the following description, numerous specific details are set forth to provide a thorough understanding of the present invention. It will be apparent, however, to one skilled in the art that the present invention can be practiced without some or all of these specific details. In other instances, well known process steps have not been described in detail in order to avoid unnecessarily obscuring the present invention.

The following discussion provides descriptions of various embodiments well suited for providing a flexible communication link that supports simultaneous high speed data and video transmission. Multiple client services can each generate data streams having different transmission requirements. The multiple data streams can be transported through the communication link using more than one transport protocol, where each transport protocol can provide transmission characteristics that match well to the data's transmission requirements. Devices in a multimedia network can adaptively use multiple protocols as a network configuration or network attached device requirements change. The communication link can provide capabilities for a complex network of devices that support both video and high speed data transfer while remaining backward compatible with existing cables and connectors.

The following description focuses on multimedia network embodiments and their modes of operation. Such networks can have one or more multimedia source devices (e.g. personal computers, multimedia servers) connected in a network to one or more sink devices (e.g. displays) through one, none or several branch devices (e.g. hubs). Typical source devices can include but are not limited to any suitable video, audio, and/or data source device including a desktop computer, portable computer, DVD player, Blu-ray player, music player, set-top box or video graphics card, among a myriad of other multimedia content transmitting devices. Typical sink devices can include but are not limited to video displays monitors, audio reproduction devices, multimedia processing systems and many other devices that can “consume” multimedia packets. Typical branch devices can include but are not limited to distribution multiplexers, repeaters, concentrators, hubs and routers that can distribute packetized streams of multimedia and/or data between a plurality of interfaces connected thereto. Each multimedia link between a source device and a sink device, or between a source device and a branch device, or between a branch device and a sink device can include multiple communication links some of which can carry unidirectional multimedia traffic (such as video or audio) and some of which can transport bidirectional data traffic (such as information or control). One example of a multimedia link is described in U.S. patent application Ser. No. 10/726,794 (Attorney Docket No. GENSP204) entitled “Packet Based Video Display Interface and Methods of Use Thereof”, which is incorporated by reference herein.

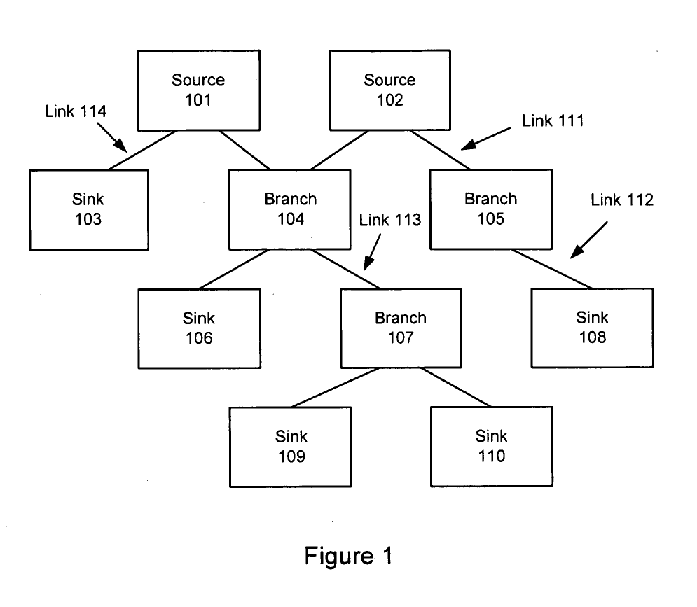

FIG. 1 illustrates an example network interconnecting two source devices to multiple sink devices either directly or through one or more branch devices. Suitable source devices can include any device that can “generate” and transmit a source signal and suitable sink devices can comprise any device that can receive and “consume” the source signal. A source device 101 that generates packetized multimedia and data traffic can be connected to a sink device 103 though a communication link 114 that supports multiple streams of multimedia and data packets. For example, the source device 101 (such as a DVD player) can generate a video stream that can be transported through the link 114 (such as a cable) to a sink device 103 (such as an LCD monitor) that can process and display the video stream. This video stream can be formatted as a series of packets transported in an isochronous stream with embedded self clocking (i.e. no separate clock signal). The stream of video packets can be transported using one or more unidirectional physical links. A separate bidirectional stream of data packets can accompany the unidirectional video stream on a separate physical link between the source device 101 and the sink device 103, both streams contained in the same cable.

With the increasing digitization of source media that includes video, audio and still photos among others, flexible multimedia source devices such as personal computers or multimedia servers can provide multiple independent high rate packetized data streams. Each packetized data stream can be routed to one or more of a plurality of sink devices through one or more branch devices within a multimedia network as illustrated in FIG. 1. Rather than transport the multiple packetized video and data streams through separate video and data communication links, such as a video VGA cable and a separate Ethernet or USB cable, an embodiment of the invention communicates packetized video streams and high rate data streams through an existing cable using a dual protocol interface. The interface described herein can provide capabilities for a more complex network of devices while remaining backward compatible with existing cables and connectors. In this way, the interface does not require adding new and separate physical connections to an existing interface, such as, for example, using previously unused pins in an existing connector (which can necessitate using a new cable).

A network capable source device can be connected indirectly to a sink device through one or more intermediate branch devices. For example, source device 102 can connect to sink device 108 through branch device 105 (via source to branch link 111 and branch to sink link 112); and source device 102 can also connect to sink device 110 though branch devices 104 and 107 (the latter connected together through link 113). Branch devices can offer various combining and separating functions for both unidirectional “media” streams and bidirectional “data” streams. For example a “splitter” branch device can divide a signal received on an input port among multiple output ports, while a “multiplexer” branch device can combine signals received on multiple input ports to a single output port. Other exemplary branch devices include replicators, concentrators, switches and hubs. It is also noted that the typical “generating”, “transferring” and “consuming” functions of source, branch and sink devices can be combined into a single hybrid device. For example a hybrid device can include a first sink device (a display) and internally a branch device (a hub) that enables connecting a second sink device (another display) or a third sink device (a storage device). Multiple branch devices can be interconnected to extend communication paths between a source device and a sink device, such as illustrated by source device 101 connected to sink device 110 through branch devices 104 and 107.

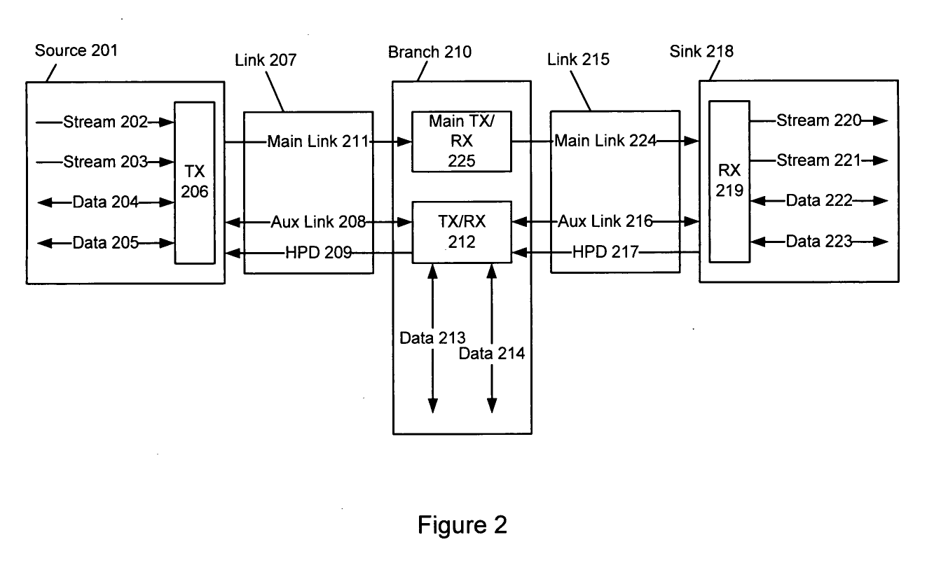

FIG. 2 illustrates selected elements of the source, branch and sink devices of FIG. 1 and of links interconnecting them. A source device 201 can include a plurality of multimedia streams 202 and 203 and data streams 204 and 205 connected to a link 207 through a “TX” transport block 206. While the label “TX” refers to the “transmitter” capability of the transport block 206 used for the unidirectional media streams 202 and 203, note that the transport block 206 also transmits and receives the bidirectional data streams 204 and 205, and thus includes elements of both a transmitter and a receiver, i.e. a transceiver. For clarity of discussion, we label the “transceivers” in the source, branch and sink devices as “TX”, “TX/RX” and “RX” respectively, but all of these “transceivers” include both transmit and receive functions for a bi-directional auxiliary link. The transport block 206 connects the source device 201 to a branch device 210 through a link 207 that includes a unidirectional main link 211 (in the source to branch direction), a bidirectional auxiliary link 208 and a hot plug detect (HPD) unidirectional link 209 (in the branch to source direction). The media streams 202 and 203 can be transported on the main link 211, while the data streams 204 and 205 can be transported on the auxiliary link 208. The main link 211 can provide high bandwidth, low latency communication using one or more physical communication channels. A main link TX/RX transport block 225 in the branch device 210 can receive the mail link 211 and repeat the mail link transmission as a main link 224 for further communication to the sink device 218.

The bidirectional auxiliary link 208 between the transport block 206 in the source device 201 and a “TX/RX” transport block 212 in the branch device 210 can be configured for half-duplex or full-duplex communication. Data packets in the data streams 204 and 205 in the source device 201 can be transported to and from the data streams 213 and 214 in the branch device 210 or communicated further to the sink device 218 through a second auxiliary link 216 contained in a second link 215. The TX/RX transport block 212 in the branch device 210 can thus the capability for multiplexing, splitting, concentrating, routing or switching data packets between a plurality of input ports and a plurality of output ports. The auxiliary link 208 can carry several types of packetized data messages between the source device 201 and other connected devices in the associated network.

The unidirectional HPD signal 209 from the branch device 210 to the source device 201 can be used to detect when an active branch device or active sink device couples to a network source device thus facilitating a robust “plug and play” capability. In some embodiments an HPD signal can be used as an interrupt request between devices. For example, in some embodiments a source device can serve as a master device for communication on a bidirectional auxiliary link with a sink device. Any transactions for data communication in either direction over the auxiliary channel can be initiated by the source device acting as a “master” controller, e.g. through a polling mechanism. In one approach, a branch device or a sink device can initiate communication to a source device in the network by sending an interrupt request through toggling the HPD signal line.

The branch device 210 illustrated in FIG. 2 does not contain an embedded sink device for the unidirectional multimedia streams and thus the main link 211 carrying the multimedia data can be connected directly to a second main link 224 in the second link 215 that terminates at a receiving “RX” transport block 219 in the sink device 218. The “RX” transport block 219 can separate the multimedia packets transported on the main link 224 into multiple streams 220 and 221. Similar to the “TX” transport block 206 in the source device 201, the “RX” transport block 219 in the sink device 218 can transmit and receive data streams 222 and 223 to and from the auxiliary link 216 that is contained in the second link 215 connected to the branch device 210. Packets in data streams 222 and 223 can be transported to/from data streams 213 and 214 in branch device 210 and to/from data streams 204 and 205 in source device 201.

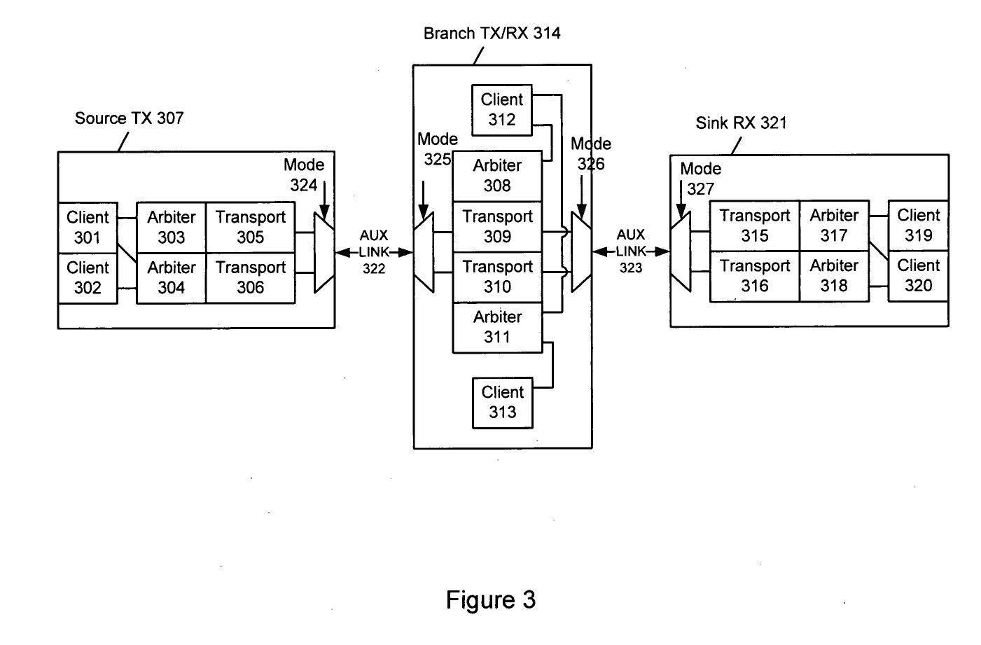

FIG. 3 illustrates a set of functional blocks to implement dual mode transport within an interconnected network of source, branch and sink devices using bidirectional auxiliary links. A source transmit (TX) block 307, which corresponds to a portion of the transmit (TX) block 206 that communicates the data streams 204 and 205 in FIG. 2, can connect two distinct client services 301 and 302 to a bidirectional auxiliary link 322 using two different communication transport protocols through transport blocks 305 and 306. Packetized data streams from both client service 301 and from client service 302 can be transported on the same auxiliary link 322 over the same physical communication channel but can use two different communication transport protocols. For example a transport block 305 can communicate packets from client 301 using a lower rate transport protocol, while transport block 306 can communicate packets from client 301 or client 302 using a different higher rate transport protocol. A mode switch 324 can determine which transport block connects to the auxiliary link 322 at any given time.

In the embodiment shown in FIG. 3, the client service 301 can use the higher rate transport protocol through transport block 306 or the lower rate transport protocol through transport block 305, while the client service 302 can only use the higher rate transport protocol through transport block 306. Different client services can require different properties from the transport protocol used. For example, data packets from the client service 301 can require only a low transfer data rate and thus can use either transport protocol, as both transport protocols can have sufficient throughput capability, while data packets from the client service 302 can require a higher transfer data rate and thus can use a higher rate transport protocol as offered by transport block 306. Other criteria can also differentiate which transport protocols can support different client services, such as reliability or guaranteed latency. In one embodiment the transport block 306 can offer a higher level of error protection when transporting data than a minimal limited error protection capability offered by transport block 305. In another embodiment, data packets communicated through the transport block 306 can incur a lower latency than data packets communicated through the transport block 305, which can influence a preferred transport protocol for each client service.

The sink receive (RX) block 321, which corresponds to a portion of the receive (RX) block 219 in the sink device 218 in FIG. 2, contains transport and client service blocks analogous to those in the source transmit (TX) block 307. Client services 319 and 320 can communicate packets through transport blocks 315 and 316, each using different transport protocols with different properties as described above for transport blocks 305 and 306 in the source transmit (TX) block 307. Similarly the branch transmit/receive (TX/RX) block 314, which corresponds to a portion of the transmit/receive (TX/RX) block 212 for the branch device 210 in FIG. 2, contains two different transport blocks 309 and 310 and a two separate client service blocks 312 and 313. The transport blocks 305, 309 and 315 can support one transport protocol with certain protocol properties, while the transport blocks 306, 310 and 316 can support a second transport protocol with different protocol properties.

A mode switch at each end of an auxiliary link can determine which transport blocks connect through the auxiliary link at any given time. For typical data transport both mode switches at each end of the auxiliary link, such as mode switches 324 and 325 connected to auxiliary link 322, can be set to connect analogous pairs of transport blocks (e.g. 305/309 or 306/310) for continuous data transmission using one of the transport protocols. However in certain circumstances, such as during initialization of the auxiliary link or during mode switching initiated by one of the blocks attached to one end of the auxiliary link, limited communication of messages transmitted using one transport protocol can be received by a transport block using a second transport protocol. For example, the mode switch 324 in the source TX block 307 and the mode switch 325 in the branch TX/RX block 314 can be set to use transport blocks 306 and 310 respectively during normal “higher rate” packet data communication. The mode switch 324 in the source TX block 307 can then be changed to use transport block 305 based on a command from a higher level protocol block (not shown), such as when re-training a unidirectional main link (not shown) that accompanies the auxiliary link 322 in the same physical cable connecting the source and branch devices. The training method for the main link can require using the protocol supported by transport block 305 across the auxiliary link 322 rather than the protocol supported by transport block 306 used for high rate data transfer. If the mode switch 325 in the branch TX/RX block 314 is still set to use the transport block 310 after the mode switch 324 in the source TX block 307 changes, then messages received on the auxiliary link 322 from the source TX block 307 can use the transport protocol supported by transport block 309 rather than transport block 310. To accommodate this “mismatch” of transport protocols, the transport block 310 in the branch TX/RX block 314 can permit reception of a limited set of messages transmitted across the auxiliary link 322 using the transport protocol for transport blocks 305/309. One such message can be a request to the branch TX/RX 314 block to switch to using the transport protocol of transport block 309 thereby changing the mode switch 325.

Each auxiliary link in a multimedia network of devices is a point-to-point link and can use its own transport protocol. Each of the auxiliary links in a network of devices can independently use different transport protocols from the other auxiliary links in the network during initialization, training and data transmission. For example auxiliary link 322 between source TX 307 and branch TX/RX 314 can use a higher rate transport protocol supported by transport blocks 306 and 310, while auxiliary link 323 between branch TX/RX 314 and sink RX 321 can use a lower rate transport protocol supported by transport blocks 309 and 315. Messages received by a branch device on a first auxiliary link using a lower rate transport protocol but destined for another device in the network using a higher rate transport protocol (for example a source device) can be “translated” before retransmission on a second auxiliary link. This translation can be accomplished in the transport blocks 309 and 310 or within a higher layer client service block 312 that shares communication with both transport blocks 309 and 310. In some embodiments, the source device can determine which transport protocol an attached sink device can use for the auxiliary link, even when connected through a number of intervening branch devices.

Each networked device that supports multiple client services and multiple transport protocols can include arbitration blocks that manage the flow of messages between the client services and the transport blocks. For example, source TX block 307 can contain an arbiter 304 that combines and distributes messages between client services 301 and 302 and the transport block 306. The arbiter 304 can ensure that neither client service 301 nor 302 dominates bandwidth for transmission through the transport block 306. Arbiters 303, 308, 311, 317 and 318 can provide similar functions for communication between client services and transport blocks in their respective devices.

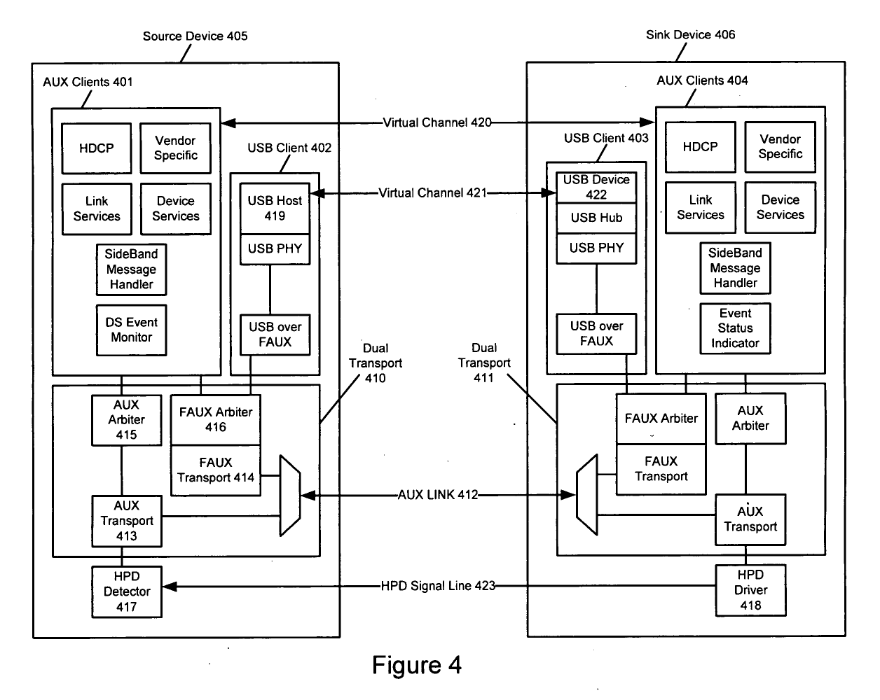

FIG. 4 illustrates an embodiment of a simple network connecting multiple client services between a source device 405 and a sink device 406 through a bidirectional auxiliary link 412 that supports two transport protocols. The client services in the source and sink devices can be considered “virtually” connected through a single physical communication channel auxiliary link. A unidirectional HPD signal line 423 also connects the two devices. The source device 405 can contain a plurality of client services (AUX clients 401) that can communicate to a plurality of client services (AUX clients 404) in the sink device 406 through either an AUX (auxiliary) transport block 413 that uses a first transport protocol or a FAUX (fast auxiliary) transport block 414 that uses a second transport protocol. In an embodiment, the AUX transport block 413 can use a lower rate transport protocol, while the FAUX transport block 414 can use a higher rate transport protocol. An arbitration block (AUX arbiter 415 when using AUX transport block 413 or FAUX arbiter 416 when using FAUX transport block 414) can combine messages from and distribute messages to multiple client services in the AUX clients block 401 communicated through the auxiliary link 412. A “high rate” client service (USB client service 402) can be transported through the FAUX transport block 414 but not through the AUX transport block 413, which can not support a high throughput required by the USB client service 402.

The dual transport block 410 in the source device and the dual transport block 411 in the sink device 406 “buffer” the client services from the specific transport protocols used on the auxiliary link 412. The client services need not know whether messages are transmitted using the AUX transport protocol or the FAUX transport protocol. An AUX client service in the source device 405 communicates through a “virtual” channel 420 to an AUX client service in the sink device 406. Similarly a USB client 402 in the source device 405 communicates through a “virtual” channel 421 to a USB client 403 in the sink device 406. As in a typical USB connection, a USB host 419 communicates with a USB device 422; however, rather than using a separate physical USB communication link using a USB specific transport protocol, USB data messages can be transported using the FAUX transport protocol over the bidirectional auxiliary link 412. The USB host 419 and USB device 422 need not know the specific transport protocol used by the dual transport blocks 410 and 411 to communicate USB data packets through the auxiliary link 412.

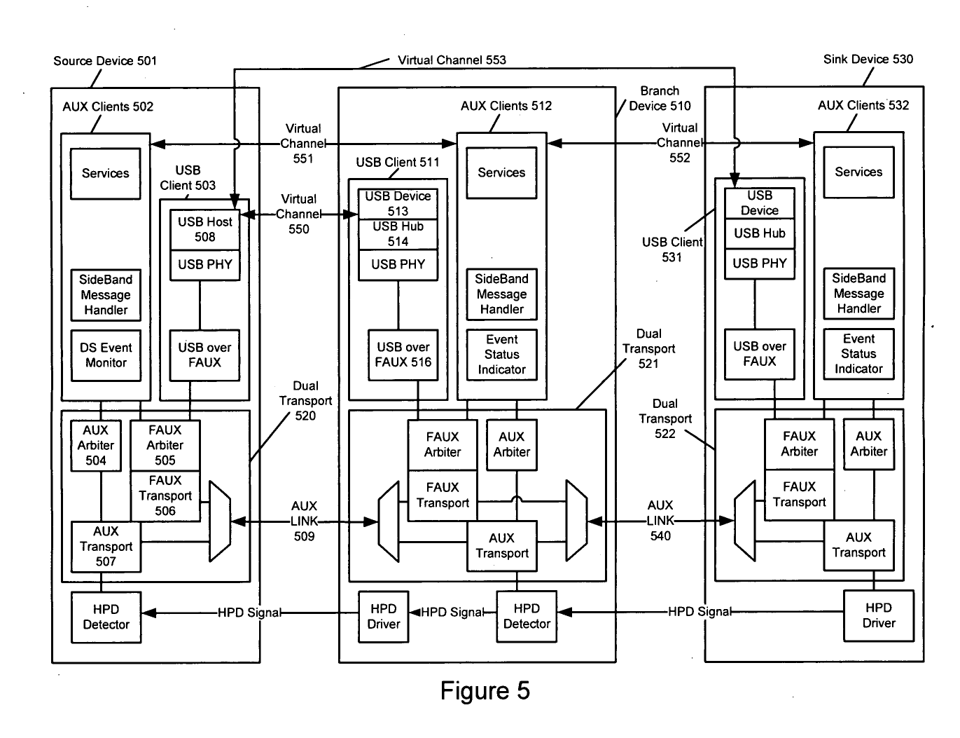

FIG. 5 illustrates a network connecting a source device 501 and a sink device 530 through a branch device 510. Auxiliary client services 502 in the source device 501 can communicate with auxiliary client services 512 in the branch device 510 through a virtual channel 551. Similarly auxiliary client services 532 in the sink device 530 can communicate with auxiliary client services 512 in the branch device 510 through a virtual channel 552. A USB host 508 in a USB client service block 503 in the source device 501 can communicate with a USB device 513 in a USB client service block 511 in the branch device through a virtual channel 550 or can communicate with a USB device in the USB client 531 in the sink device 530 through virtual channel 553. The virtual channels 551 and 553 provide USB connections between the USB host 508 and two different USB client devices that can offer better performance than a typical “physical” USB connection. For example, the auxiliary links 509 and 540 that transport the USB traffic can extend to distances many times that required by a physical USB connection.

Other embodiments can include additional client services to transfer data messages using the FAUX transport protocol through the auxiliary links. For example the USB client services 503, 511 and 531 can be supplemented by a parallel set of Ethernet client services connected similarly to the FAUX arbitration blocks in the dual transport blocks. As such, Ethernet data packets can be transported through an auxiliary link without adding additional physical communication lines to an existing cable or interface to support the Ethernet protocol. The FAUX arbiter blocks can balance access to the FAUX transport block and AUX links between the USB client services and the Ethernet client services. Alternatively, Ethernet data packets from an Ethernet client service may be transported by embedding the Ethernet data packets within USB messages generated by a USB client service that uses the FAUX transport block over the AUX link, i.e. by communication between parallel client services before communication through the FAUX transport blocks and over the AUX links.

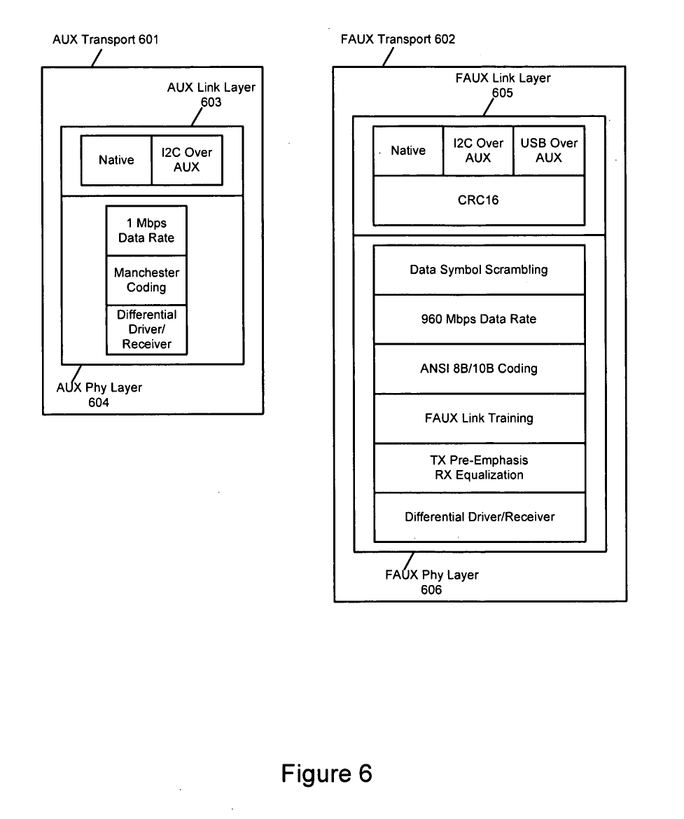

FIG. 6 summarizes properties of exemplary physical layer protocols and link layer protocols in the transport protocol blocks of a dual transport block. An AUX transport block 601 can include an AUX physical layer 604 that connects an AUX link layer 603 with a physical communication line. The AUX physical layer 604 can use a differential driver and receiver to couple the device containing the AUX transport block 601 to the physical communication line. The AUX physical layer 604 can use Manchester encoding that supports a data rate of 1 Mbps and uses the encoded data stream directly for clock recovery, i.e. no separate clock signal required. A receiver using an AUX physical layer 604 can quickly adapt a phase lock loop because of frequent signal transitions in a received Manchester encoded signal. The AUX physical layer 604 primarily enables bit level transmission, and the AUX link layer 603 enables packet level transmission by grouping bits into formatted packets. Different link layer protocols can use different packet formats over the same physical layer transmission. For example the AUX link layer 603 can support one packet format (labeled “Native”) for data messages inherent to the AUX transport protocol on the auxiliary channel and a second packet format (labeled “I2C Over AUX”) for data messages that can carry messages originating from an “external” I2C bus to be transported over the auxiliary channel.

The FAUX transport block 602 can include a FAUX physical layer 606 that supports a higher data rate than the AUX physical layer 604 and a FAUX link layer 605 that can transport messages from an external high speed interface such as USB (shown) or Ethernet (not shown). The FAUX physical layer 606 can use the same differential driver and receiver as the AUX physical layer 604 to couple the devices to the physical auxiliary communication line; however, the FAUX physical layer can support a much higher data rate of 960 Mbps using ANSI 8B/10B encoding. Note that the signaling rate on the auxiliary communication line can be (10/8)*960 Mbps=1.2 Gbps to support the 960 Mbps data rate. Other signaling rates can be used on the auxiliary communication line for different data rates and encoding schemes. The FAUX physical layer 606 transmitter can use transmit pre-emphasis to shape the encoded signal for better transmission through the communication medium. The FAUX physical layer 606 receiver can use receive equalization to improve detection of the encoded signal after attenuation by the communication medium and in the presence of additive noise. The FAUX physical layer 606 can also use data symbol scrambling to ensure the encoded bit stream is randomized for improved transmission. Note that the ANSI 8B/10B encoding method assures a DC balanced stream of ones and zeroes with a maximum run length of 5 zeros, thus ensuring sufficiently frequent signal transitions to enable clock recovery using only the received data signal. As with the AUX physical layer 604, no separate clock signal is required by the FAUX physical layer 606.

The FAUX transport block 602 can include a FAUX link layer 605 that supports the same packet message formats used in the AUX link layer 603 (e.g. “Native” and “I2C Over Aux”) in addition to a third packet message format “USB Over Aux” used for data messages originating from an “external” USB host, hub or device. The FAUX link layer 605 can add a two byte cyclic redundancy check (CRC16) to each packet message for detection of transmission errors. Other link layer error correction methods can also be applied to permit both the detection and correction of errors in received packet messages. The FAUX link layer 605 can thus offer greater error protection than the AUX link layer 603, even when using the same “base” format for each packet message.

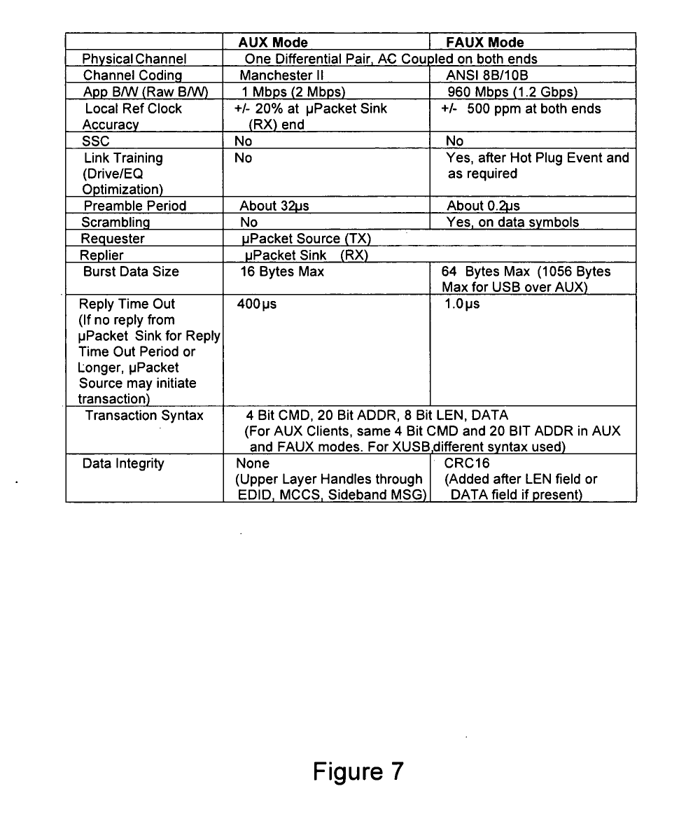

FIG. 7 summarizes properties of an exemplary dual transport protocol using a first auxiliary (AUX) mode and a second fast auxiliary (FAUX) mode. In both modes, each end of the auxiliary channel can use AC coupling and differential transmission. The AUX mode can use a first channel coding method (e.g. Manchester II) while the FAUX mode can use a second channel coding method (ANSI 8B/10B). Both modes can include sufficient data transitions to ensure that clock recovery can work without the presence of a separate clock signal as noted earlier. The auxiliary channel can use link training in the FAUX mode to optimize transmit and receive capabilities at each end when a device is added or removed from the network. This link training can optimize a transmit pre-emphasis driver and a receive equalizer to better match the physical layer signaling path to measured characteristics of the physical communication line. Each mode can use a different format for packet messages received from different client services, although many of the fields within the different packet message formats can be the same. For example in the AUX mode, an AUX client service's packet message can include a 4 bit command field, a 20 bit address field, an 8 bit length field and between 0 and 16 bytes of data. In the FAUX mode, an AUX client service's packet message can include a 4 bit command field, a 20 bit address field, an 8 bit length field and between 0 and 64 bytes of data followed by a 16 bit CRC field. Thus the FAUX mode can use the same format for AUX client service's packet messages as the AUX mode supplemented by an additional CRC16 field and a larger number of data bytes.

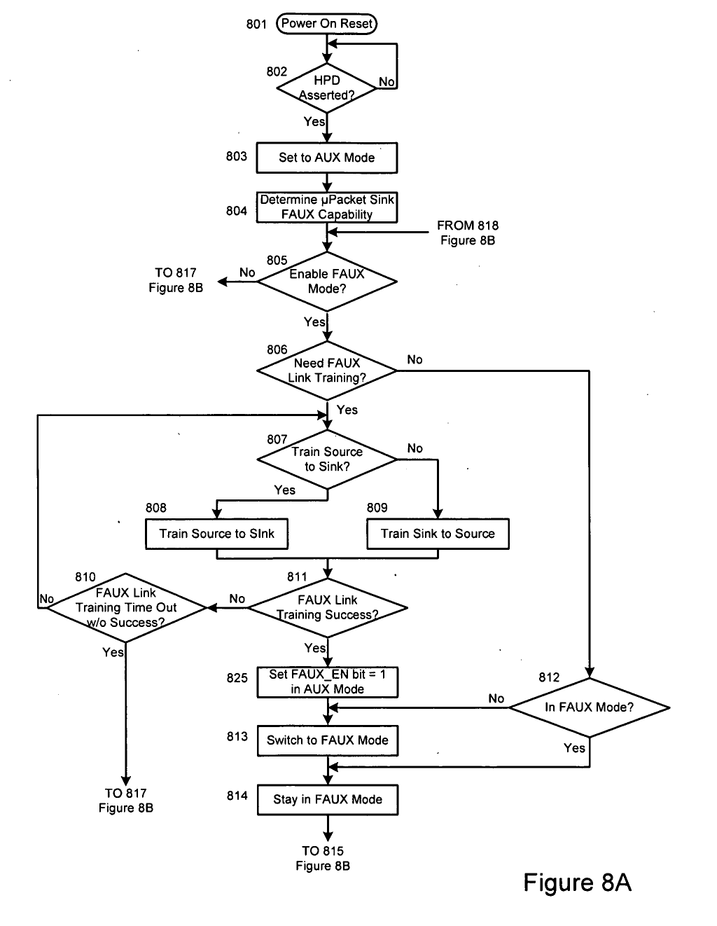

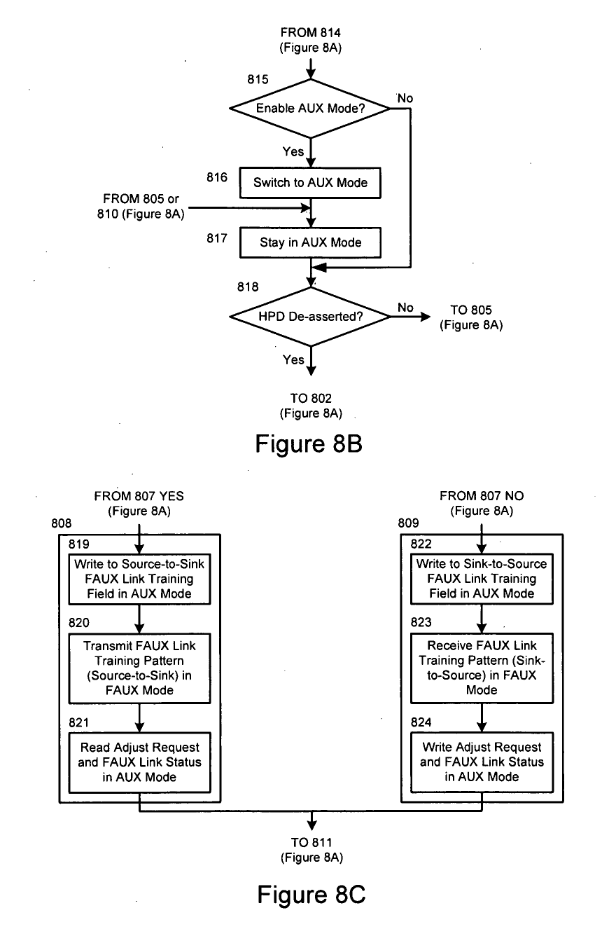

As the dual transport blocks 410 and 411 in the source and sink devices 405 and 406 respectively can be configured by a mode switch to use either a lower data rate AUX mode or a higher data rate FAUX mode, the mode switches can need to be configured during initialization. For example when a source or sink device is powered on or when a source or sink device is added or deleted from either end of an auxiliary channel the mode switches can need to be set or changed. FIGS. 8A, 8B and 8C illustrate a flow chart for setting the mode switch in a source device that includes appropriate link training when using the FAUX mode. In step 801 a power on reset of a source device results in the mode switch being in an unknown state. In step 802, the source device determines if a second network device (a branch or sink device) is connected to a physical communication link by checking if a hot plug detect (HPD) is asserted. The source device cycles repeatedly through hot plug detection until HPD is positively asserted. In step 803, once HPD is asserted, the source device defaults to AUX mode. Any newly attached device in a network can default to a “lowest common denominator” mode to ensure basic communication capability. In step 804 the source device can determine if an attached branch/sink device (i.e. the device that triggered the HPD assertion) is able to use FAUX mode. This determination can be accomplished by sending a message (using AUX mode) to the branch/sink device that reads a field in the source/sink device that describes its capabilities. In step 805 the source device can choose to enable FAUX mode (branch to step 806) or can choose to stay in AUX mode (branch to step 817 in FIG. 8B). The source device can choose to not enable FAUX mode, for example, if the sink device does not support FAUX mode determined in step 804. The source device can also stay in AUX mode if no client services in the source device require the additional capabilities (higher rate, greater error protection, lower latency etc.) of FAUX mode.

If the source device does choose to enable FAUX mode, then the source device determines if FAUX link training is required in step 806. In some cases, FAUX link training can be bypassed; for example, a previously calculated set of link training parameters for the pre-emphasis driver and receiver can have been stored and still be used without additional link training. In this “previously trained” case, the source device can switch to FAUX mode (step 813) if it's determined that the source device is not already in FAUX mode (step 812). If FAUX link training is required, the source device can train both directions of the bidirectional auxiliary channel. In step 808 the source device to sink device direction can be trained while in step 809, the sink device to source device direction can be trained. Both directions can be required to train successfully for the FAUX link training to be declared successful in step 811. The source device can indicate to the sink device successful training and switch to FAUX mode by sending a message using AUX mode with a FAUX enable bit set. (Note that as described below the sink device will default initially to AUX mode and thus can only receive the FAUX enable message using an AUX mode message.) The source device can then switch to FAUX mode in step 813. To avoid an endless loop of unsuccessful FAUX link training, step 810 checks if a FAUX link training time out occurs, in which case the source device can stay in AUX mode as indicated by the branch to step 817 of FIG. 8B.

FIG. 8C illustrates a set of steps for training each direction of the bidirectional auxiliary channel. The source to sink direction link training (step 808) includes three steps: (1) sending a message from the source device to the sink device in AUX mode indicating FAUX link training will start (step 819), (2) transmitting a FAUX link training pattern in FAUX mode (step 820), and (3) sending a message from the source device to the sink device in AUX mode to read any transmitter or receiver adjustments determined by the FAUX link training and to check on the FAUX link status (step 821). With successful FAUX link training indicated from the sink device to the source device, the source device can then perform sink to source direction FAUX link training (step 809). The source to sink direction link training (step 809) also includes three steps: (1) sending a message to the sink device in AUX mode (step 822) to initiate FAUX link training in the sink to source direction, (2) receiving a FAUX link training pattern in FAUX mode (step 823), and (3) sending a message to the sink device in AUX mode writing any transmitter or receiver adjustments determined during the link training and reading FAUX link status. The source device can calculate its own receiver equalization settings based on the received FAUX link training pattern as well as a transmitter pre-emphasis setting for the sink device. After successful FAUX link training in both directions (step 811) the source device can enable FAUX mode in the sink device (step 825) and switch to FAUX mode itself (step 813).

After entering FAUX mode, the source device can choose to remain in FAUX mode (step 814) until the HPD is de-asserted (step 818) in which case the source device can return to step 802 awaiting HPD assertion. The source device can also choose to switch to AUX mode independently (step 816) and remain in AUX mode (step 817) until it later decides to switch back to FAUX mode (repeat of step 805). Note that the source device acts as a “master” device while the sink device acts as a “slave” device for mode selection.

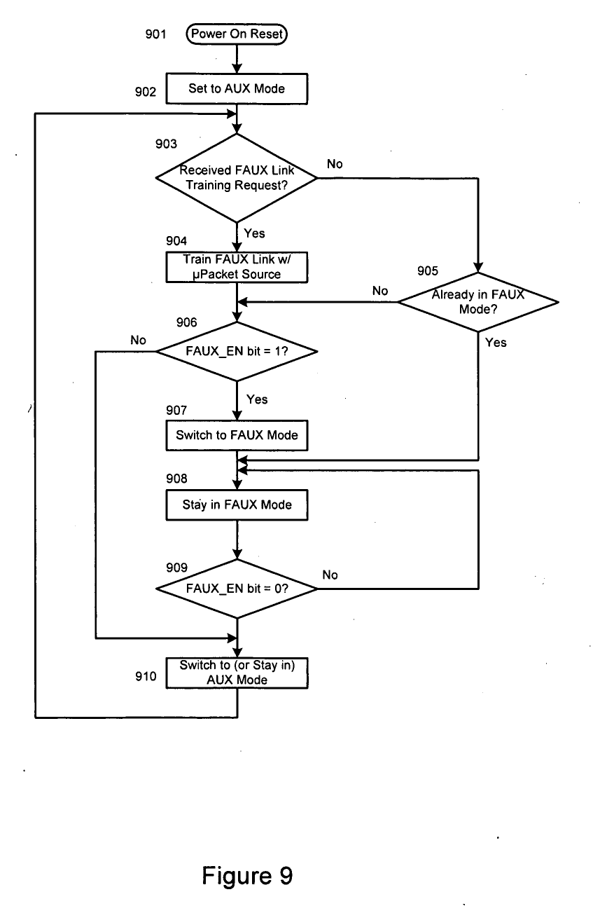

FIG. 9 illustrates a flow chart of the steps that a sink device can take to set its auxiliary channel mode. After power on reset (step 901) the sink device can default to AUX mode (step 902). The sink device can remain in AUX mode until it receives a FAUX link training request message (step 903) transmitted from the source device in AUX mode. The sink device can undertake FAUX link training in both directions (step 904) under the control of the source device as described earlier for steps 819-824 of FIG. 8C. After completing FAUX link training the sink device stays in AUX mode until receiving a message with a FAUX enable bit set to one (step 906). The sink device then switches to FAUX mode (step 907) and remains in FAUX mode (step 908) until the source device sends a message with the FAUX enable bit set to zero (step 909). Note that both messages containing the FAUX enable bit can be sent using the AUX mode (not the FAUX mode). Thus a sink device in FAUX mode can receive successfully at least one message transmitted using AUX mode that indicates a required mode switch.

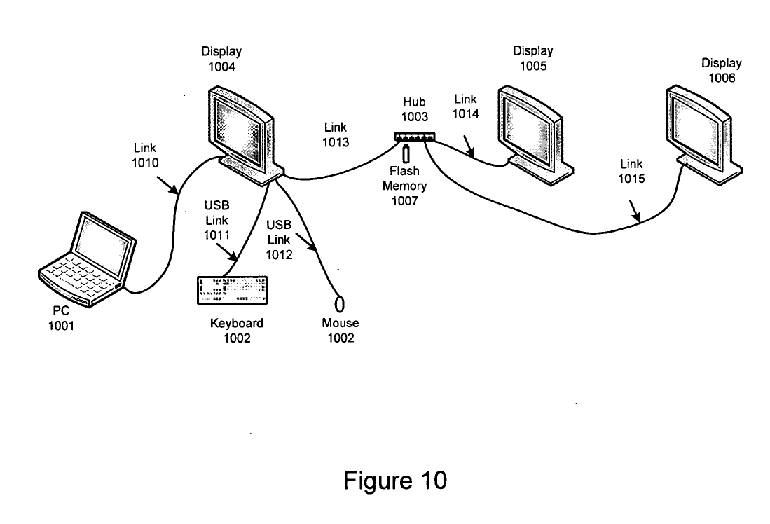

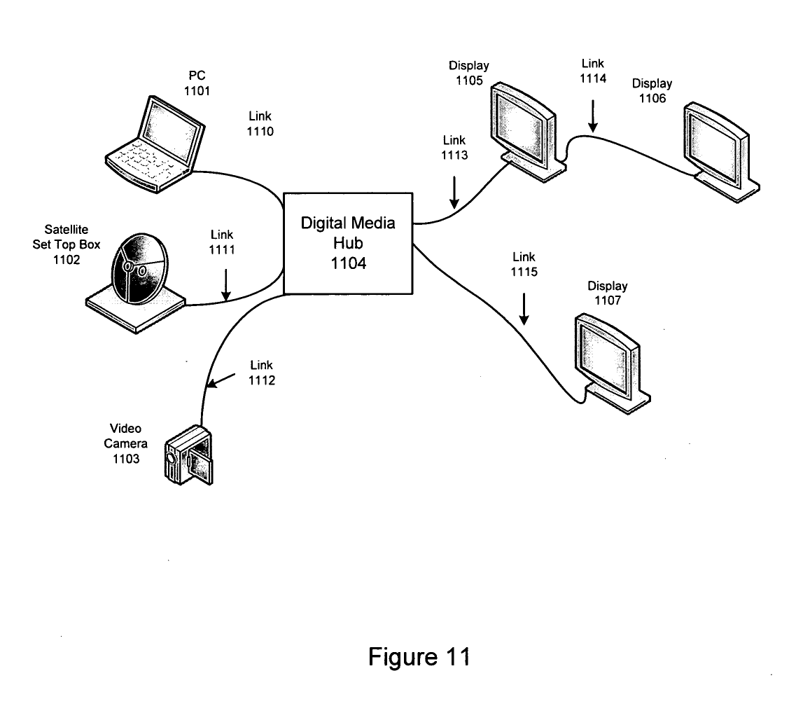

FIG. 10 illustrates a network in accordance with an embodiment of the invention. A laptop computer source device (PC 1001) connects to a branch/sink device (Display 1004) through a link 1010 that includes a unidirectional packetized video main link and a bidirectional packetized auxiliary link. The packetized video on the main link can be displayed on the display 1004 and can also be re-transmitted further on a second link 1013. A USB keyboard sink device 1002 and a USB mouse device 1002 can connect to the branch/sink device (Display 1004) through a USB link 1011 and USB link 1012 respectively. The USB devices can communicate with the source device (PC 1001) through the dual transport capability of the auxiliary link contained in the link 1010. All or part of the information received on the link 1010 can be transmitted to a branch device (hub 1003) through the link 1013. Thus hub device can connect a USB device (flash memory 1007) to the source device (PC 1001) through the chain of link 1013 and link 1010. The hub device can also distribute video information and auxiliary channel information through link 1014 and link 1015 to sink devices (Displays 1005 and 1006) respectively. FIG. 10 illustrates how a source/host device (PC 1001) can distribute a digital video stream to multiple displays and simultaneously communicate digital packet information with other peripheral devices (Keyboard 1002, Mouse 1002, Flash Memory 1007) using a single protocol over common cabling.

FIG. 12 illustrates another network in accordance with an embodiment of the invention. A digital media hub 1104 device acts as a source device for three different display devices (1105-1107) connected either directly or indirectly to the digital media hub by links 1113, 1114 and 1115. The links 1113, 1114 and 1115 can contain video information multiplexed by the digital media hub 1104 from three different video source devices, namely a PC 1101, a satellite set top box 1102 and a video camera 1103. The 1110-1112 links that connect these source devices to the digital media hub 1104 can be the same or different from the links 1113-1115 depending on the capabilities of these source devices. For example the PC 1101 can connect by an Ethernet link 1110, the satellite step top box 1102 by an HDMI link 1111, and the video camera 1103 can connect by a USB link 1112. The digital media hub can aggregate both video and “data” information from these devices and distribute them to the sink display devices 1105-1107 through the links 1113-1115 using a multimedia protocol as described herein. As explained above, a multimedia protocol link can support a mixture of unidirectional video and bidirectional data packets simultaneously on a single cable offering a flexible network for distributing media (and data) within a multimedia network.

In addition, embodiments of the present invention further relate to integrated circuits and chips (including system on a chip (SOC)) and/or chip sets as well as firmware for performing the processes just described. By way of example, each of the devices described herein can include an integrated circuit chip or SOC for use in implementing the described embodiments and similar embodiments. Embodiments can also relate to computer storage products with a computer-readable medium that has computer code thereon for performing various computer-implemented operations. The media and computer code can be those specially designed and constructed for the purposes of the present invention, or they can be of the kind well known and available to those having skill in the computer software arts. Examples of tangible computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter. Computer readable media can also be computer code transmitted by a computer data signal embodied in a carrier wave and representing a sequence of instructions that are executable by a processor.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. It will be apparent to one of ordinary skill in the art that many modifications and variations are possible in view of the above teachings.

The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. A packet based display interface configured to operate in a multimedia device in a network, the interface comprising:
a media transport block configured to communicate video packets across a first unidirectional link;
a dual data transport block configured to communicate a first packet message across a bidirectional link to or from a first client service block using a first transport protocol and to communicate a second packet message to or from a second client service block using a second transport protocol; and
a detection block configured to determine an addition or a deletion of a network device using a second unidirectional link opposite in direction to the first unidirectional link;
wherein the first and second unidirectional links and the bidirectional link each use separate physical communication lines bundled together in a common cable.

2. The interface recited in claim 1 wherein the dual data transport block further comprises:
a first arbitration block that combines messages from a plurality of client services in the first client service block for communication across the bidirectional link through a first transport block using the first transport protocol, and
a second arbitration block that combines messages from the plurality of client service blocks in the first client service block and messages from the second client service block for communication across the bidirectional link through a second transport block using the second transport protocol.

3. The interface recited in claim 2 wherein the first transport block comprises a first physical layer block and a first link layer block coupled differentially to the bidirectional link operating at a first signaling rate of at least 1 Mbps, and the second transport block comprises a second physical layer block and a second link layer block coupled differentially to the bidirectional link operating at a second signaling rate of at least 1 Gbps.

4. The interface recited in claim 3 wherein the first link layer block is configured to use a first message format for communicating messages from the first client service block across the bidirectional link, and the second link layer block is configured to add a cyclic redundancy check field to the first message format for communicating messages from the first client service block across the bidirectional link, and the second link layer block is configured to use a second message format, distinct from the first message format, for communicating messages from the second client service block across the bidirectional link.

5. The interface recited in claim 3 wherein the second physical layer block is configured to adjust a bidirectional link transmitter or receiver contained therein when the detection block determines the addition or the deletion of the network device.

6. The interface recited in claim 3 wherein the dual data transport block is configured to use either the first transport protocol or the second transport protocol based on a mode switch.

7. The interface recited in claim 6 wherein the dual data transport block is configured to detect a message communicated using the first transport protocol when the mode switch is set to use the second transport protocol.

8. The interface recited in claim 3 wherein the first physical layer block is configured to use Manchester encoding for the first transport protocol, and the second physical layer block is configured to use ANSI 8B/10B encoding for the second transport protocol.

9. A method for training a packet based display interface in a multimedia source device to use dual transport protocols, the method comprising:
detecting by the multimedia source device a connection of a multimedia sink device to the packet based display interface through a unidirectional link in the sink-to-source direction;
exchanging a set of messages across a bidirectional link between the multimedia source device and the multimedia sink device using a first transport protocol to determine a transport protocol capability of the multimedia sink device and to enable training each direction of the bidirectional link;
transmitting and receiving training patterns across the bidirectional link between the multimedia source device and the multimedia sink device using a second transport protocol if the multimedia sink device supports the second transport protocol;
sending a message by the multimedia source device across the bidirectional link to the multimedia sink device using the first transport protocol setting the multimedia sink device to use the second transport protocol;
wherein the unidirectional link and the bidirectional link each use separate physical communication lines bundled together in a common cable connected between the multimedia source device and the multimedia sink device.

10. The method recited in claim 9 wherein the first transport protocol uses a first signaling rate of at least 1 Mbps, and the second transport protocol uses a second signaling rate of at least 1 Gbps.

11. A method for training a packet based display interface in a multimedia sink device to use dual transport protocols, the method comprising:
receiving by the multimedia sink device across a bidirectional link from a multimedia source device a message using a first transport protocol requesting training of the bidirectional link;
transmitting and receiving training patterns across the bidirectional link between the multimedia source device and the multimedia sink device using a second transport protocol if the multimedia sink device supports the second transport protocol;
receiving by the multimedia sink device a message from the multimedia source device across the bidirectional link using the first transport protocol setting the multimedia sink device to use the second transport protocol;
wherein the bidirectional link and a first unidirectional link in the source-to-sink direction and a second unidirectional link in the sink-to-source direction all use separate physical communication lines bundled together in a common cable connected between the multimedia source device and the multimedia sink device.

12. The method recited in claim 11 wherein the first transport protocol uses a first signaling rate of at least 1 Mbps and the second transport protocol uses a second signaling rate of at least 1 Gbps.

13. An electronic device configured to operate in a multimedia network, the device comprising:
media transport circuitry configured to communicate video packets across a first unidirectional link;
dual data transport circuitry enabling the device to transmit and receive packetized data messages through a bidirectional communication link using a first transport protocol for data messages from a first client service and using a second transport protocol for data messages from a second client service;
detection circuitry configured to determine the presence of a second electronic device in the multimedia network through a second unidirectional link opposite in direction to the first unidirectional link;
wherein the first and second unidirectional links and the bidirectional link each use separate physical communication lines bundled together in a common cable.

14. The electronic device recited in claim 13 wherein the dual data transport circuitry further comprises:
first arbitration circuitry that combines data messages from a plurality of client services that includes the first client service for communicating through the bidirectional link using the first transport protocol; and
second arbitration circuitry that combines data messages from the plurality of client services that includes the first client service and from the second client service for communicating data messages through the bidirectional link using the second transport protocol.

15. The electronic device recited in claim 14 wherein the first transport protocol includes a first physical layer protocol operating at a first signaling rate of at least 1 Mbps and the second transport protocol includes a second physical layer protocol operating at a second signaling rate of at least 1 Gbps.

16. The electronic device recited in claim 14 wherein the first transport protocol includes a first link layer protocol that uses a first message format for the data messages from the plurality of client services and the second transport protocol includes a second link layer protocol that uses a second message format that adds a cyclic redundancy check field to the first message format for the data messages from the plurality of client services or from the second client service.

17. The electronic device recited in claim 13 wherein the dual data transport circuitry is configured to use the first transport protocol or the second transport protocol based on a mode switch.

18. The electronic device recited in claim 17 wherein the dual data transport circuitry is configured to detect a data message communicated using the first transport protocol when the mode switch is set to use the second transport protocol.

19. The electronic device recited in claim 15 wherein the first physical layer protocol uses Manchester encoding and the second physical layer protocol uses ANSI 8B/10B encoding.

20. A computer program product having computer readable instructions for communicating video packets and packetized data messages through a multimedia network, the computer program product comprising:
computer readable instructions for communicating video packets across a unidirectional link;
computer readable instructions for transmitting and receiving packetized data messages through a bidirectional communication link using a first transport protocol for data messages from a first client service and using a second transport protocol for data messages from a second client service; and
computer readable instructions for determining the presence of a network device in the multimedia network through a second unidirectional link opposite in direction to the first unidirectional link;
wherein the first and second unidirectional links and the bidirectional link each use separate physical communication lines bundled together in a common cable.

21. The product recited in claim 20 further including:
computer readable instructions for combining data messages from a plurality of client services that includes the first client service for communicating through the bidirectional link using the first transport protocol;
computer readable instructions for combining data messages from the plurality of client services and from the second client service for communicating through the bidirectional link using the second transport protocol; and
computer readable instructions for detecting a data message communicated using the first transport protocol when the product is configured to use the second transport protocol.

22. The product recited in claim 21 wherein the computer readable instructions are embedded in the hardware of an integrated circuit.
